(19) United States
(12) Patent Application Publication
(10) Pub. No.: US 2018/0099227 A1
(43) Pub. Date: Apr. 12, 2018

(54) Educational Toy

(71) Applicant: Kimberly Broderick, Escondido, CA (US)

(72) Inventor: Kimberly Broderick, Escondido, CA (US)

(21) Appl. No.: 15/728,308

(22) Filed: Oct. 9, 2017

Related U.S. Application Data
(60) Provisional application No. 62/406,873, filed on Oct. 11, 2016.

(51) Int. Cl. A63H 3/28; G09B 1/00

(52) U.S. Cl. CPC A63H 3/28; A63H 2200/00; G09B 1/00

(57) ABSTRACT

This invention is directed toward a plush toy with a number of educational features that are either manufactured into it or removable attachable as accessories. The toy is to be used for teaching mindfulness, and has particular applicability for children who will be better able to learn and express themselves through a toy that can serve as a sort of alter ego as they grow.

### CROSS REFERENCE TO RELATED APPLICATIONS

This application claims priority back to U.S. Provisional No. 62/406,873, filed Oct. 11, 2016, the contents of which are incorporated by reference and a copy of which is attached to this application.

### STATEMENT REGARDING FEDERALLY SPONSORED RESEARCH OR DEVELOPMENT

This invention was not federally sponsored.

### BACKGROUND OF THE INVENTION

Field of the invention the general field of educational toys, and more specifically, to a plush toy with a number of educational components to it. By way of brief summary, the toy is designed to teach children how to meditate and increase their mindful awareness, and has a number of optional accessories to allow the toy to effectively deal with a wide range of children and their various needs. The invention can be better described through viewing the various figures and their description.

### BRIEF DESCRIPTION OF THE FIGURES

One preferred form of the invention will now be described with reference to the accompanying drawings.

FIG. 1 is a front view of “Mindful Madi” showing some of the key features.

FIG. 2 is a side view showing more key features.

FIG. 3 is a close-up perspective view of the head region of the invention.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through two views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

### REFERENCE NUMBERS

15. Ears

16. Eyes

17. Arms

18. Snout

19. Bottom paws

20. Fur

21. Invention generally

22. Thinking Cap

23. Voice/Music recorder chip

24. Tail

25. Side zipper or bottom pouch

26. Paw notes

27. Paw patch

28. Cap patch

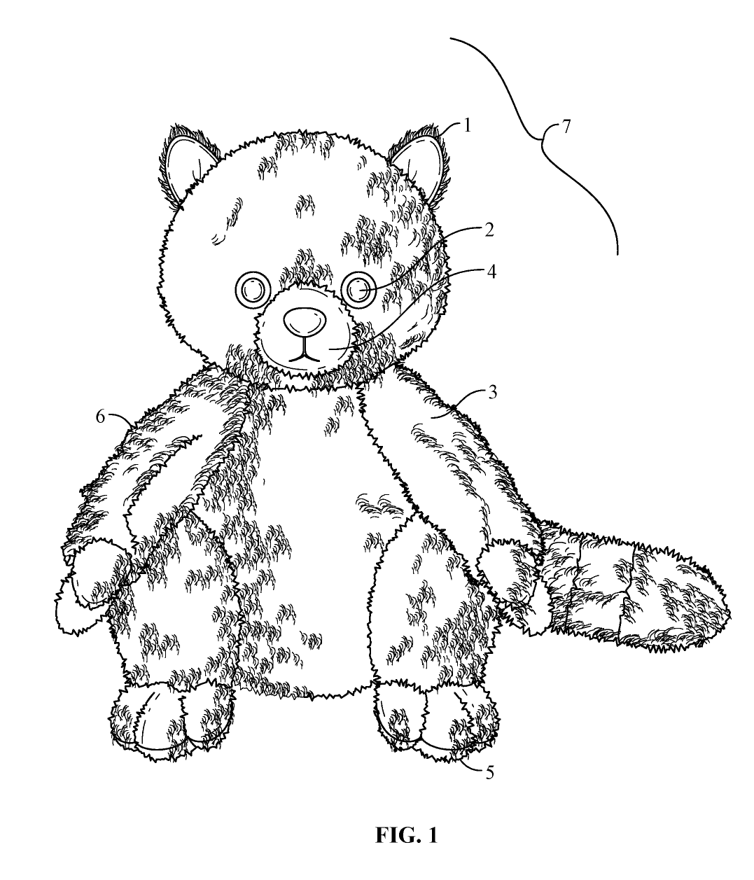

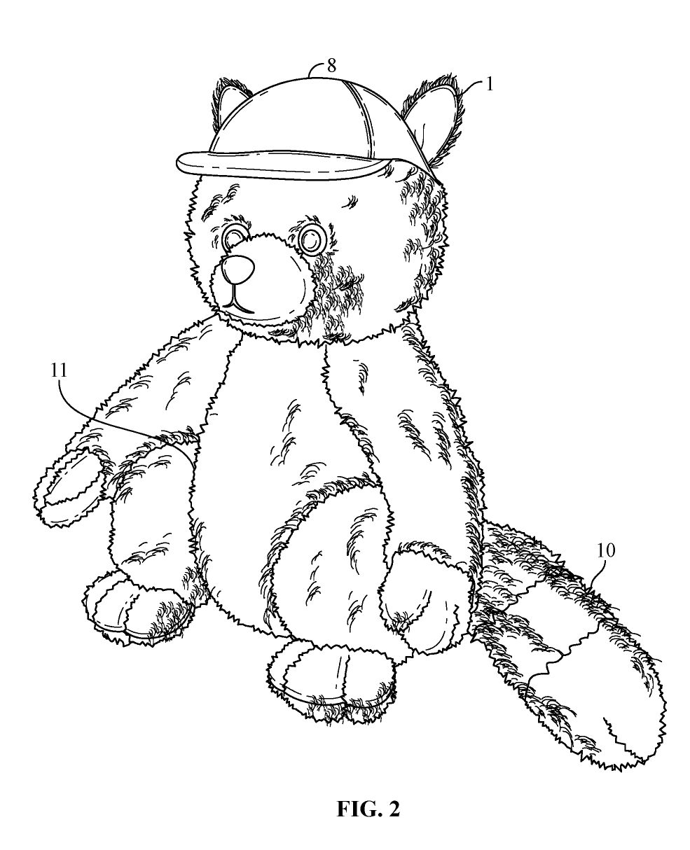

FIG. 1 is a front view of the invention, “Mindful Madi”, generally referenced as 7, showing some of the key features. FIG. 2 is a side, perspective view of “Mindful Madi”. The invention is basically a plush toy designed to be attractive to a child, with large, round eyes 2, a snout 4, fluffy ears 1, a cap 8, two arms 3, two bottom paws 5, a and tail 10. The ears 1 are pointed, upright and bendable. The eyes 2 are round with a variety of colors in the irises. In a preferred embodiment, the snout 4 can be wheat in color with a black nose and a black mouth. The bottom paws 5 have black stitching to highlight the claws. The fur 6 is soft and plushy, with the entire head, body and tail being a cinnamon color, with wheat color for the inner ear, inner torso from neck to bottom, upper and lower paws, and where the tail has wheat and cinnamon stripes. The fur 6 can be customized in different colors and made from a number of different substances and textures, including but not limited to plastic, non-allergenic substances, and composite materials. The tail 10 is relatively long and can be striped, as in this iteration of the invention, spotted, or with other color combination.

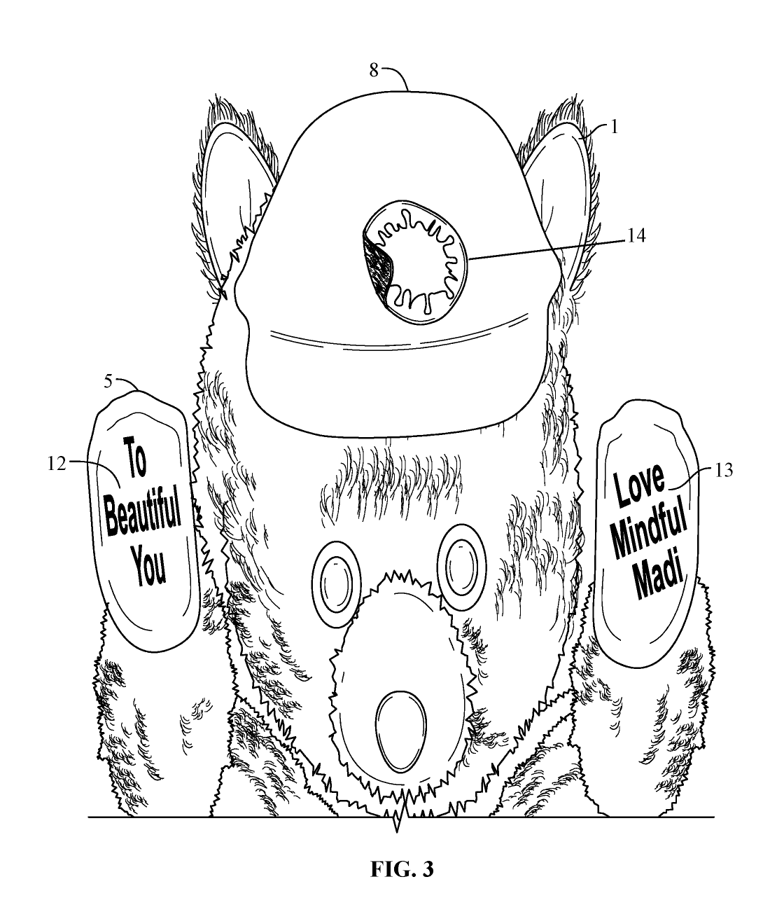

FIG. 3 is a close-up perspective view of the head region of the invention.

There can be paw notes on the paws 12 and cap patches 14 on the cap 8 which can be either permanent or removable/exchangeable, such that a teacher can reward or remind a child who is behaving poorly by changing a message and/or color of the paw note. The “thinking cap” 8 is designed for the toy and can be customized for a child. The cap is removable and has a removable patch which can be customized, color-coded, word-coded, or otherwise variable to enhance its effectiveness as a teaching tool to encourage a child to focus his/her thoughts during meditation periods, as well as communicate his/her emotions through the toy. In addition to being a meditation tool for children, it is anticipated that the invention will also be used by special education teachers who may use weighted objects to calm children down. The invention has optional zippered pouches on the side, bottom, or other optimum location, into which a teacher can slip one or more weighted objects such as bean bags to apply the correct amount of weight to a child.

The theory behind the invention is to provide an interactive toy that a child will desire greatly, but that a teacher, parent, or other caregiver can use to give the child feedback on how he/she is behaving. Because the toy, rather than the adult, is providing the feedback, the child will be more receptive as his/her behavioral changes will be due to affection for the toy rather than being afraid of, or annoyed by, the caregiver.

The following is an excerpt from a children's picture book in progress, “Magical Moments with Mindful Madi,” relating to the effective use of this toy to teach children how to meditate by helping them slow down, breathe deeply, and focus their thoughts on positive phrases or “mindful mottos” with the goal of improving their mindful awareness, self-control, empathy and respect for others.

### Magical Moments with Mindful Madi

Oliver's dreams were interrupted by the soft, quick footsteps of Madi the Mindful Mongoose. Madi was Oliver's mentor. Madi helped Oliver be mindful.

“Wake up, Oliver, let's get ready for quiet time.” said Madi. She nudged the blanket from Oliver's face with her pointy snout. Oliver's big, brown eyes peered at Madi. “I'm tired. Let's skip quiet time.” said Oliver.

“What?” said Madi. She sprung into the air, flipped over and landed next to Oliver.

“When we're mindful we make right choices . . . like getting out of bed, sleepy head.” said Madi.

Madi glided to the floor. She put on her “thinking cap.” Her ears poked through the top; a patch on the front said, “Be Still & Feel Chill.”

Oliver pretended to be an airplane. He swooped over to Madi and plopped down. “What do you want to think about during quiet time today?” asked Madi.

Oliver opened a small box. He sorted through colorful patches. Each patch had a mindful motto written on it. One patch said, “I AM JOY,” another said, “I AM CURIOUS,” another said “I AM SMART.”

Madi handed Oliver his “thinking cap.” Oliver stuck a patch on the front of his cap that said, “I AM LOVE.” He slipped the cap over his head.

Madi winked at Oliver. “When you're ready, sit comfortably and relax.” Oliver sat cross-legged; his hands rested in his lap. He closed his eyes. “Breathe deeply and slowly.” Madi whispered. Oliver Breathed in. Oliver breathed out. But Oliver was fidgety.

Oliver blinked at Madi. “I can't concentrate.” said Oliver. “Sometimes it's hard to be still.” said Madi. “Let's try again. If you get distracted, think about our mindful motto.”

Oliver closed his eyes. Oliver breathed in. Oliver breathed out. He repeated, “I am love. I am love . . . I . . . am . . . love.”

Oliver's eyes popped open. “It's not working, Madi. My brain won't settle down; it's bouncing around!” Madi rested her chin on her front paw. “Hmm . . . ” she sighed.

“I know!” exclaimed Madi. “Lie flat on your back.” Oliver slid down. Madi climbed on top of Oliver's belly. “Watch me go up and down as you breathe in and out.” said Madi.

Oliver breathed in through his nose. His belly filled with air. Madi went up. Oliver breathed out through his nose. His belly lost air. Madi went down.

Oliver closed his eyes. Oliver breathed in.

Oliver breathed out. Oliver looked peaceful.

A short time later, Madi hopped off Oliver's belly. “Well? asked Madi. “How was quiet time?”

Oliver's eyes sparkled. “When I smile, share, and give hugs . . . I am love.” said Oliver. “Great job!” giggled Madi. “Let's get ready for school.”

Oliver opened his backpack; Madi jumped inside. “Even when things don't go our way, we'll try to be mindful and spread love today.” said Madi.

They arrived at school and helped Teacher Judy erase set up computers. They shared crayons with their classmates.

They welcomed a new friend at lunch. They danced and pranced.

They played games with their family. They cleaned up their toys.

Oliver yawned. He had on his favorite pajamas. “I'd say we've had a mindful day.” said Madi.

“I'll be ready for quite time tomorrow.” said Oliver. “I love you, Mindful Madi.” He squeezed Madi tightly. “I love you, too, Oliver. Happy dreams.”

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. An educational toy, consisting of a body, a furry exterior, two arms, four paws, where the four paws comprise two upper paws and two bottom paws, a tail, two eyes, a snout, two ears, and a cap, where the cap additionally comprises a removable patch.

2. The educational toy of claim 1, where at least one of the two upper paws and at least one of the two bottom paws additionally comprises a paw note.

3. The educational toy of claim 2, where the paw note is permanent.

4. The educational toy of claim 2, where at least one of the upper paws and at least one of the bottom paws additionally comprises an attachment surface, and additionally comprising at least two removable patches, where the at least two removable patches additionally comprise and feedback item, where a teacher can apply a certain feedback item to the attachment surface to provide feedback to a child using the educational toy.

5. The educational toy of claim 4, where the feedback item is selected from the group consisting of two or more colors, motivational messages, symbols and two or more scents.

6. The educational toy of claim 5, additionally comprising at least one weight and at least one zippered pouch, where at least one weight is capable of fitting in the at least one zippered pouch.

7. The educational toy of claim 6, where there is at least one zippered pouch on a side of the invention and where there are at least two different weights, each of which is capable of fitting in the at least one zippered pouch.

8. The educational toy of claim 7, additionally comprising a Voice/Music recorder chip and a birth tag.

9. The educational toy of claim 8, additionally comprising one or more articles of clothing, where one of the one or more articles of clothing is a shirt, and, additionally comprising a meditation pillow.

10. The educational toy of claim 9, additionally comprising a coloring book, a neck pillow and a back pack.

11. An educational toy, comprising a body, a furry exterior, two arms, four paws, where the four paws comprise two upper paws and two bottom paws, a tail, two eyes, a snout, two ears, and a cap, where the cap additionally comprises a removable patch.

12. The educational toy of claim 11, where at least one of the two upper paws and at least one of the two bottom paws additionally comprises a paw note.

13. The educational toy of claim 12, where the paw note is permanent.

14. The educational toy of claim 12, where at least one of the upper paws and at least one of the bottom paws additionally comprises an attachment surface, and additionally comprising at least two removable patches, where the at least two removable patches additionally comprise and feedback item, where a teacher can apply a certain feedback item to the attachment surface to provide feedback to a child using the educational toy.

15. The educational toy of claim 14, where the feedback item is selected from the group consisting of two or more colors, motivational messages, symbols and two or more scents.

16. The educational toy of claim 14, additionally comprising at least one weight and at least one zippered pouch, where at least one weight is capable of fitting in the at least one zippered pouch.

17. The educational toy of claim 14, where there is at least one zippered pouch on a side of the invention and where there are at least two different weights, each of which is capable of fitting in the at least one zippered pouch.

18. The educational toy of claim 14, additionally comprising a Voice/Music recorder chip and a birth tag.

19. The educational toy of claim 14, additionally comprising one or more articles of clothing, where one of the one or more articles of clothing is a shirt, and, additionally comprising a meditation pillow.
